(19) United States
(12) Patent Application Publication
(10) Pub. No.: US 2021/0331186 A1
(43) Pub. Date: Oct. 28, 2021

(54) FLUID LINE SYSTEM AND CORRESPONDING METHOD

(71) Applicant: Jörg KRÜGER, Schwandorf (DE)

(72) Inventor: Jörg KRÜGER, Schwandorf (DE)

(21) Appl. No.: 16/322,754

(22) PCT Filed: Jun. 12, 2017
(86) PCT No.: PCT/EP2017/000683

§ 371 Date: Feb. 1, 2019

(30) Foreign Application Priority Data
Aug. 11, 2016 (DE) 10 2016 009 734.5

(51) Int. Cl. B05B 7/04; B05B 7/16

(52) U.S. Cl. CPC B05B 7/0483; B05B 7/16; B05B 7/0433

(57) ABSTRACT

A fluid line system including at least one liquid supply line, at least one gas supply line and at least two elongated fluid conduits is provided. Of the at least two elongated fluid conduits, at least one fluid conduit is an outer fluid conduit which completely encloses another fluid conduit which is inner fluid conduit. The liquid supply line is connected to the outer fluid conduit so that a liquid fluid can flow between the inner and outer fluid conduits. The gas supply line is connected to the inner fluid conduit so that a gaseous fluid can flow in the inner fluid conduit. A method for injecting a fluid mixture through a nozzle supplied by the fluid system is also.

### CROSS-REFERENCE TO RELATED APPLICATIONS

This application is a Section 371 of International Application No. PCT/EP2017/000683, filed Jun. 12, 2017, which was published in the German language on Feb. 15, 2018, under International Publication No. WO 2018/028807 A1, which claims priority under 35 U.S.C. § 119(b) to German Application No. 10 2016 009 734.5, filed Aug. 11, 2016, the disclosures of which are incorporated herein by reference in their entirety.

### BACKGROUND OF THE INVENTION

The present invention relates to a fluid line system for directing fluids to, in particular, spray nozzles, or for the introduction of fluids by means of spray nozzles within hot or cold spaces.

Whenever a medium is introduced into a space, for example injected through a nozzle, this medium must be directed to the place of its introduction, for example to the nozzle. Supplying the medium directly from the outside is the simplest way, but it is not available for many nozzle arrangements or is associated with disadvantages.

For example, it would be advantageous to direct the medium to a movable nozzle through a pipe running within the space. However, this supply through a space is particularly problematic when in the space at least one of the media has a very high or a very low temperature, relative to the melting or boiling temperature.

In another application, described in patent DE 4315385 A1, a liquid nitrogen-containing reducing agent is injected through two-fluid nozzles into the stream of hot flue gases, for selective non-catalytic reduction of nitrogen oxides. In the method described, injection occurs in pulsating operation at a frequency of 5 to 70 Hz, preferably 10 to 20 Hz. As a result of this mode of operation, a spray cone of relatively coarse long-range drops and a spray cone of relatively fine short-range drops are produced alternately at each two-fluid nozzle. The nozzles are installed in the boiler wall. The effort to protect the nozzle is relatively low.

This pulsating injection serves to ensure a distribution of the injected medium that is as homogeneous as possible with regard to the distance from the nozzle.

If, for example because one aims at achieving a homogeneous distribution despite large boiler dimensions, it is undesirable to dispose the nozzles directly in the boiler wall and they are instead to be arranged at a position further inside, one is faced with the above-described problems in terms of supply.

In addition, during supply of the fluids to the nozzles, deterioration of the above-described homogeneity may occur.

These problems constitute a major disadvantage of the prior art.

### BRIEF SUMMARY OF THE INVENTION

An object of the present invention was to overcome the disadvantages of the prior art and to provide a fluid line system by means of which a user is able to realize a simple supply of a medium to a nozzle in a space, independently of the position of the nozzle, even in adverse temperature conditions, or in order to carry out a homogeneous injection.

This object is achieved by a fluid line system according to the claims.

The fluid line system according to the present invention comprises at least one supply line for a liquid fluid (liquid supply line), at least one supply line for a gaseous fluid (gas supply line) and at least two elongated fluid conduits, in particular from the group of pipes and hoses, at least one fluid conduit of which (outer fluid conduit) completely encloses another fluid conduit (inner fluid conduit), wherein the liquid supply line is connected to the outer fluid conduit so that a liquid fluid can flow between the inner and outer fluid conduits, that is, between the respective walls, and wherein the gas supply line is connected to the inner fluid conduit so that a gaseous fluid can flow in the inner fluid conduit.

The outer fluid conduit can therefore also be referred to as a “liquid conduit” and the inner fluid conduit can accordingly be referred to as a “gas conduit”. The walls of these fluid conduits are of course designed so that they can carry the respective fluid, i.e. a liquid or a gas. If no further fluid flows between the two conduits, the outer wall of the gas conduit must of course be adapted such that a liquid can flow along it since the liquid flows between the walls of the inner fluid conduit (gas conduit) and the outer fluid conduit (liquid conduit).

The fluids are known in the art and are chosen depending on the result to be achieved. According to the invention, one of the fluids must be a liquid and one of the fluids must be a gas. Furthermore, the fluid line system may comprise further fluid conduits for supplying a liquid or gaseous fluid.

Suitable liquid supply lines and gas supply lines are known in the art. Due to the different properties of the two fluid types, supply lines for liquids are clearly distinguishable from supply lines for gases. Preferably, the gas supply line is adapted for supplying gases with a pressure of >2 bar, in particular >4 bar. However, the pressure preferably does not exceed 10 bar.

For example, a pressure of >2.3 bar noticeably improves the homogeneity of injection. The gas volume passed through per unit time is preferably between 500 l/h and 5000 l/h per square centimeter of the cross-sectional area of the gas conduit.

According to a preferred embodiment, the liquid supply line comprises a liquid pump and/or the gas supply line comprises a gas pump, and in particular one or both supply lines additionally comprise(s) an open-loop control or closed-loop control system for controlling the respective pump. This has the advantage that the system is able to control or automatically control the inflow of the liquid and/or of the gas.

According to another embodiment, which can be readily combined with the preceding one, the liquid supply comprises a liquid reservoir and/or the gas supply comprises a gas reservoir.

Although the fluids are not usually part of the invention, they are essential for optimal performance during operation, and they flow through the conduits.

Of course, the supply lines are located at that end of the fluid conduits which, in accordance with the invention, is located opposite the connection to a nozzle.

The fluid conduits comprise, in particular, pipes and/or hoses. Preferably, a fluid conduit has a triangular or polygonal or a round cross-section.

Preferred materials for the walls of the fluid conduits are metal, glass fibers or carbon fibers and/or plastic. Preferably, the thermal conductivity of the wall of the outer fluid conduit is greater than the thermal conductivity of the wall of the inner fluid conduit.

A preferred thermal conductivity of the wall of the outer fluid conduit is greater than 8 W/(m·K), in particular >20 W/(m·K), or even >50 W/(m·K). This has the advantage that the liquid flowing outside can serve to cool or heat the wall and, if appropriate, the gas in the interior can be heated so that its pressure rises.

A preferred thermal conductivity of the wall of the inner fluid conduit is less than 8 W/(m·K), in particular <1 W/(m·K), or even <0.2 W(m·K). This has the advantage, for example, that the gas flowing in its interior is shielded somewhat from the temperatures prevailing outside.

The fluid conduits of the fluid line system are preferably adapted to be flexible. A preferred outer shape (in particular, the wall of the outer fluid conduit) is that of a corrugated tube or a corrugated hose. This has the advantage that an optimum supply can be realised even for movable nozzle systems.

The fluid conduit is preferably longer than 5 m, in particular longer than 10 m, or it is even 20 m long or longer. The inner diameter of the outer fluid conduit is preferably less than 10 cm, in particular less than 5 cm or even less than 2 cm (in the case of alternating cross-sectional shapes, in each case, the smallest inner diameter is meant). The inner diameter of the inner fluid conduit is, in particular, less than 90%, preferably less than 60%, or even <40% of the inner diameter of the outer fluid conduit.

According to the invention, an outer fluid conduit completely encloses an inner fluid conduit. Preferably, the walls of the two fluid conduits do not touch over the entire length of the fluid conduits (apart from optional spacers).

The two fluid conduits preferably run coaxially with each other.

The inventive effect of a liquid being able to flow between the inner fluid conduit and the outer fluid conduit and of a gas being able to flow in the inner fluid conduit has the advantage that the thermal coefficient of the liquid, which is higher compared to that of the gas, is exploited in order to attenuate the effect the adverse temperature conditions (heat or cold) in the room have on the fluid line system, in particular on its outer wall. Particularly when the fluids are directed through a hot space (ambient temperature >150° C. or even >800° C.), good supply and, later on, injection can be achieved in this way despite of the routing of the fluid conduits through the space.

In the case of a routing through a cold space, there is the additional effect that the temperature, which is increased due to the pressure increase of the gas, heats the liquid from inside, and consequently, in addition to controlling the temperature of the outer wall, the liquid is prevented from freezing and the gas is simultaneously cooled, so that during subsequent injection an optimal temperature control of the injected fluid mixture can be achieved.

According to a preferred embodiment, the fluid line system in addition includes at least one further fluid conduit. A further fluid conduit may run inside the inner fluid conduit, between the inner fluid conduit and the outer fluid conduit, or in/on the wall of one of the other fluid conduits. It may also enclose the inner fluid conduit. This has the advantage that a fluid for cooling or heating can be passed through the at least one fluid conduit.

According to a preferred embodiment, at least two of the fluid conduits are separated from one another in a fluid-tight manner. However, it can also be advantageous if one of the fluids, such as a gas, can penetrate the separation.

According to a preferred embodiment, the fluid line system preferably includes at least one temperature sensor, with at least one temperature sensor preferably being arranged at the fluid outlet. One temperature sensor is preferably arranged at the fluid inlet, particularly if the temperature of the fluids at the inlet is not known.

Although it is basically sufficient to know the temperature of the liquid, it is preferable to measure the temperature of at least one further fluid (e.g. of the gas) as well.

Preferably, the fluid line system further comprises a closed-loop control system for controlling the temperature, the pressure or the flow rate of the fluids. Thus, the fluid flow can be regulated depending on the temperature.

According to a preferred embodiment, the fluid line system, at the end which in accordance with the invention faces a nozzle, comprises a mixing chamber for mixing the liquid and the gas, and in particular a pressure reducer (throttle) in addition thereto. This embodiment is particularly preferred for nozzles that have one single throttle orifice or which at least inject the liquid and the gas in a mixed state.

According to another preferred embodiment, the fluid line system, at the end which in accordance with the invention faces a nozzle, comprises a chamber for interchanging the flow path of the gas being carried in the inner fluid conduit with the liquid carried between the outer fluid conduit and the inner fluid conduit. This is particularly preferred for injection by means of nozzles in which the liquid is passed through a central pipe that is surrounded by a second pipe carrying a gaseous atomizing agent which atomizes the liquid on exit.

The inventor has recognized that a satisfactory supply of liquid and gas to a nozzle cannot be achieved in ways other than the one prescribed by the invention, or, as the case may be, only at the expense of having to accept disadvantages.

According to a preferred embodiment, the system comprises, at the opposite end of the supply lines, a nozzle system comprising at least one nozzle, in particular a single-fluid or two-fluid nozzle. Particularly preferred is a nozzle as described in this application.

According to a particular embodiment, incorporating a nozzle, this embodiment does not necessarily include the above-mentioned fluid line system (although this system is very advantageous), but includes merely any fluid supply line, a throttle, a chamber located behind the throttle, seen in the direction of flow, for expansion, and finally the nozzle orifice.

According to a preferred embodiment, the fluid line system, provided with a nozzle, comprises a throttle (pressure reducer) between the fluid conduits and the nozzle system. This results in the fluids being able to expand for the first time, downstream the throttle, even before exiting the nozzle orifice. This improves the homogeneity of the injection. The diameter of this throttle is usually dependent on the diameter of the fluid conduits and on fluid pressure. Good results were achieved with throttles whose flow area had a diameter that approximately equaled the diameter of the inner fluid conduit. Preferably, the diameter of the flow area of the throttle is thus between 50% and 150% of the diameter of the inner fluid conduit, that is, of the diameter of the “gas conduit”. In practice, preferred throttle diameters are between 0.5 and 1.5 cm. Preferably, the throttle is arranged downstream of a mixing chamber, in which the liquid is mixed with the gas. In the case of a prior mixing of the two fluids, these must of course flow through the throttle orifice together.

According to a preferred embodiment which, in particular, builds on the above-described embodiment, the diameter of the flow area of the throttle is at least 5% larger or at least 5% smaller than the diameter of the inner fluid conduit, that is, than the diameter of the “gas conduit”. Particularly preferably, the diameter of the flow area of the throttle is thus between 50% and 95% and/or between 105% and 150% of the diameter of the inner fluid conduit (gas conduit).

When injecting by means of a preferred nozzle, a pressurized medium is injected into the space through a nozzle comprising a nozzle chamber and an outlet orifice or a group of outlet orifices for all injected fluids. This can also be achieved, for example, by feeding the liquid, mixed with the pressurized gas, to the nozzle.

Preferably, this mixing is achieved in that a throttle (pressure reducer) is arranged in front of the nozzle and that the system is designed such that the liquid and the gas mix in front of the throttle and are thereafter jointly expanded in the throttle. The next expansion then occurs in the outlet slot of the nozzle, and, in particular, leads to a pulsation effect.

Preferred liquid flow rates are 200-6001/h per square centimeter of the cross-sectional area of the flow area of the liquid conduit.

Preferred nozzle orifices are between 0.1 mm and 2 mm, in particular between 0.4 mm and 1 mm. With slot nozzles, these dimensions correspond to the slot width.

If injection is carried out by means of another preferred nozzle, a pressurized medium (propellant) is used to atomize a second medium as it exits an orifice, and in this way inject it into the space. In the above-mentioned DE 4315385 A1, a liquid flows within a central tube located in the nozzle towards the nozzle orifice and is atomized by a gas flowing concentrically around it and thereby introduced into the space.

A preferred injection method using an above-described device, including a preferred nozzle, comprises the steps:
supplying a liquid, separately from a gas, under an adjustable pressure, to a mixing chamber,
mixing of liquid and gas, and passing these through a throttle closing the mixing chamber,
expansion of the liquid-gas mixture downstream the throttle, in a nozzle chamber,
injecting the liquid-gas mixture,

wherein the pressure of the supplied liquid and/or the pressure of the supplied gas is adjusted so that a periodically alternating injection takes place.

For example, this adjustment can be made in a very simple manner by increasing the pressure of the gas or the pressure of the liquid starting from value 0 until a pulsating injection can be seen. Through slight changes in pressure, e.g. by 0.1 bar, a change in the pulsation can be achieved.

In addition, it is preferred that when the amount of fluid is increased, the amount of gas is increased simultaneously, to optimize pulsation.

It is also preferred, upon reaching a periodically alternating injection in the last step of the above-mentioned method, to further increase the gas pressure and to measure whether there occurs an improvement in injection.

It is also preferred, upon increase in pressure, to reduce the throttle orifice and to measure whether there occurs an improvement in injection.

It is also preferable to reduce the size of the nozzle orifice and to measure whether there is an improvement in injection. The nozzle orifice in particular affects the exit velocity and drop size under otherwise identical conditions.

It is also preferable to change the distance of the throttle from the nozzle orifice in order to adjust the frequency of the pulsation. A reduction of the distance increases in particular the frequency.

Where injection has been improved it can be maintained in that improved form or be further improved by the above-mentioned options, e.g. by varying the above-mentioned quantities until no longer any improvement occurs.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 schematically shows a preferred fluid line system.

FIG. 2 schematically shows a preferred embodiment incorporating a nozzle.

FIG. 3 shows, by way of example, the distribution of the injected fluid.

### DETAILED DESCRIPTION OF THE INVENTION

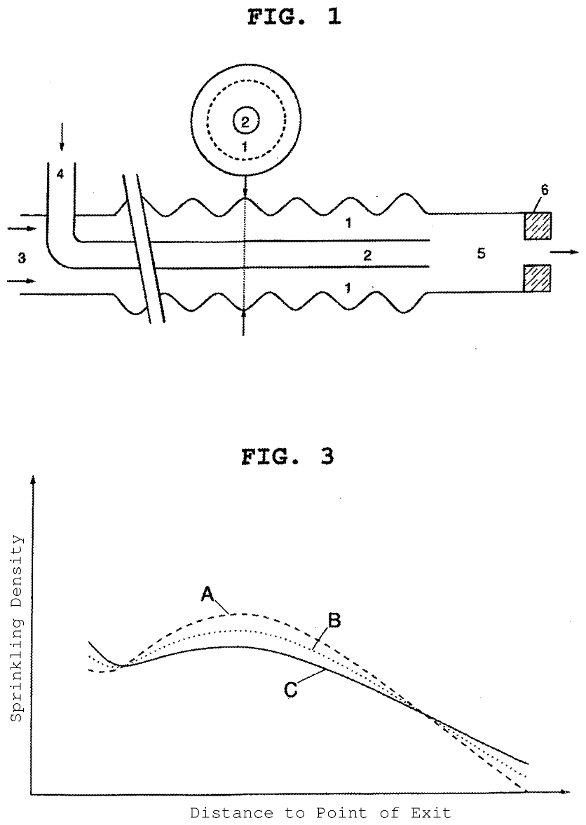

FIG. 1 schematically shows a preferred fluid line system. This fluid line system comprises a liquid conduit 1 (in which the oblique section is to indicate an elongated design), a gas conduit 2, which is enclosed by the liquid conduit 1 (see cross-sectional representation above the middle arrow). The liquid conduit is designed as a corrugated tube, which is only a preferred embodiment, however. The liquid is introduced into the fluid line system through a liquid supply line 3, and the gas is directed through a gas supply line 4 (arrows on the left) into the central tube.

On the right hand-side of the fluid line system, an optional mixing chamber 5 is shown, in which the liquid can mix with the gas. Attached to the mixing chamber there is an optional pressure reducer 6, through which the liquid-gas mixture can exit (right arrow).

FIG. 2 schematically shows a preferred embodiment, including a nozzle. This embodiment, too, comprises the inventive fluid line system including the fluid conduit 1 (in which an oblique section is to indicate an elongated design), the gas conduit 2, the liquid supply line 3 and the gas supply line 4. In a mixing chamber 5, the liquid and the gas mix and enter a nozzle chamber 7 through a pressure reducer 6. This expands the gas somewhat. Through the nozzle 8, the mixture finally exits, as indicated by the dashed lines. In this way, periodically discrete distance intervals, or a wide distance interval, can be sprayed.

FIG. 3 shows, by way of example, the distribution of the injected fluid achieved by an arrangement according to FIG. 2, in the form of 3 curves, A, B and C. This distribution can also be referred to as “sprinkle density”. On the x-axis, the graph shows the distance from the point of exit of the fluid mixture, i.e. the place where the fluid leaves the nozzle, and on the y-axis, the graph shows the amount of fluid which, given an undisturbed flight, would reach a certain floor area (see also the various sprinkling positions of the dashed trajectories in FIG. 2).

Since the absolute progression of the curves depends on several factors, such as the position of the nozzle above the ground, the liquid pressure, the gas pressure or the throttle diameter, the graph only shows the qualitative progression at different gas pressure and/or at different liquid pressure. The remaining parameters are assumed to be constant. In curve A the pressure is lowest, curve C has the highest pressure, and curve B has a pressure between those of curves A and C.

It can be seen that as the pressure increases, a flattening of the curve occurs, which corresponds to a more homogeneous injection, seen over the distance. From a certain pressure (not shown), the homogeneity decreases again, since chaotic processes take place during injection. The corresponding distribution depends very much on the type of these chaotic processes, so that a representation is impracticable.

In one practical example, compressed air, together with a reaction liquid, is directed to a nozzle in a 20-m-long corrugated hose in which another hose, having a diameter of 8 mm, runs coaxially thereto.

The compressed air is directed within the central hose, and the reaction liquid is directed within the corrugated hose outside the central tube. In front of a throttle, the liquid mixes with the compressed air, and they are jointly expanded behind the throttle. The next expansion occurs in the outlet slot of the downstream nozzle and, given a correct adjustment of the pressure, even leads to an automatically occurring pulsation effect.

For this design, practical quantities for the liquid and for the compressed air are 0-3200 liters/h at 5 bar for the compressed air, and 500-1200 l/h for the liquid. The slot of the nozzle is 0.1-1 mm, for example, and the throttle diameter is between 0.5 and 1.5 cm.

Using the above arrangement, a sufficiently uniform distribution of the liquid is achieved with little effort in terms of control technology. With a higher quantity of air, the distribution becomes more homogeneous. The throwing distance is increased by the supply of air.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-10. (canceled)

11. A fluid line system comprising:
at least one liquid supply line (3);
at least one gas supply line (4); and
at least two elongated fluid conduits (1, 2), of which at least one fluid conduit is an outer fluid conduit (1) which completely surrounds another fluid conduit which is an inner fluid conduit; (2),
wherein the liquid supply line (3) is connected to the outer fluid conduit (1) so that a liquid fluid can flow between the inner fluid conduit and the outer fluid conduit,
wherein the gas supply line (4) is connected to the inner fluid conduit (2) so that a gaseous fluid can flow in the inner fluid conduit (2), and
wherein the thermal conductivity of the wall of the outer fluid conduit (1) is greater than the thermal conductivity of the wall of the inner fluid conduit (2).

12. The fluid line system according to claim 11, wherein the gas supply line (4) is adapted for supplying gases with a pressure of >2 bar, wherein, preferably, the liquid supply line (3) comprises a liquid pump and/or the gas supply line (4) comprises a gas pump, and, in particular, one of the supply lines or both supply lines additionally include(s) an open-loop control or closed-loop control system for the particular pump.

13. The fluid line system according to claim 11, wherein the thermal conductivity of the wall of the outer fluid conduit (1) is greater than 8 W/(m·K), and/or the thermal conductivity of the wall of the inner fluid conduit (2) is less than 8 W/(m·K).

14. The fluid line system according to claim 11, wherein the fluid line system additionally comprises at least one further fluid conduit, through which a fluid for cooling or heating can be passed.

15. The fluid line system according to claim 11, wherein the fluid line system includes a closed-loop control system for controlling the temperature, the pressure or the flow rate of the fluids, and that the fluid line system preferably includes at least one temperature sensor, wherein preferably at least one temperature sensor is arranged at the fluid outlet.

16. The fluid line system according to claim 11, wherein, at an end which faces a nozzle (8), it comprises a mixing chamber (5) for mixing the liquid and the gas, or a chamber for interchanging the flow path of the gas, which is directed in the inner fluid conduit (2), with the liquid, which is carried between the outer fluid conduit (1) and the inner fluid conduit (2).

17. The fluid line system according to claim 16, wherein, between the fluid conduits (1, 2) and the nozzle system (7, 8) or the intended position of the nozzle, it comprises a throttle (6) which, in particular, is arranged downstream a mixing chamber (5), wherein the diameter of the flow area of the throttle (6) is preferably between 50% and 150% of the diameter of the inner fluid conduit (2), particularly preferably between 50% and 95% and/or between 105% and 150% of the diameter of the inner fluid conduit.

18. The fluid line system according to claim 16, wherein it comprises, at the opposite end of the supply lines (3,4), a nozzle system (7, 8) including at least one nozzle (8) through which the fluids can exit.

19. A nozzle system equipped with a fluid line system according to claim 11.

20. An injection method, using a device according to claim 11, the method comprising the steps of:
supplying a liquid, separately from a gas, under an adjustable pressure, to a mixing chamber (5),
mixing of liquid and gas, and passing these through a throttle (6) closing the mixing chamber (5),
expansion of the liquid-gas mixture downstream the throttle (6), in a nozzle chamber (7), and
injecting the liquid-gas mixture into a space, wherein the pressure of the supplied liquid and/or the pressure of the supplied gas is adjusted so that a periodically alternating injection takes place.
